(19) United States
(12) Patent Application Publication
(10) Pub. No.: US 2025/0239967 A1
(43) Pub. Date: Jul. 24, 2025

(54) SOLAR PANEL WASHER

(71) Applicants: Christopher NYSTROM, St. Albert (CA); Carrie NYSTROM, St. Albert (CA)

(72) Inventor: Christopher NYSTROM, St. Albert (CA)

(73) Assignees: Christopher NYSTROM, St. Albert, AB (CA); Carrie NYSTROM, St. Albert, AB (CA)

(21) Appl. No.: 18/853,898

(22) PCT Filed: Mar. 31, 2023
(86) PCT No.: PCT/CA2023/050441

§ 371 Date: Oct. 3, 2024

(30) Foreign Application Priority Data
Apr. 5, 2022 (CA) 3154319

(51) Int. Cl. H02S 40/10; A46B 13/04; A46B 15/00

(52) U.S. Cl. CPC H02S 40/10; A46B 13/04; A46B 15/0004; A46B 15/0055; A46B 2200/3073

(57) ABSTRACT

A solar panel washer has a frame that is supported by a set of frame wheels. The frame has at least one elongate support that has a first end and a second end. The frame wheels are positioned such that the frame wheels rotate on a top surface of a solar panel to allow the frame to move along the solar panel or a set of aligned solar panels. At least one nozzle is positioned on the frame. The at least one nozzle is attached to a hose such that a cleaning solution is sprayed onto the top surface of the solar panel. At least one brush is supported on the frame such that it contacts the top surface of the solar panel.

### FIELD OF THE DISCLOSURE

The present application relates generally to a solar panel washer, and more particularly relates to a solar panel washer for use on a grid of solar panels.

### BACKGROUND

This section provides background information to facilitate a better understanding of the various aspects of the invention. It should be understood that the statements in this section of this document are to be read in this light, and not as admissions of prior art.

Solar panels and solar panel grids have become more popular as an alternative energy source. With sufficient sun exposure, a solar panel grid may allow a building or business to go “off-grid” or reduce the requirement for energy from the grid. Over time, solar panels can become dirty which can greatly affect the ability of the solar panels to take in energy from the sun. When this happens, solar panels need to be carefully cleaned in a manner that thoroughly cleans the solar panel while preventing the positioning of the panel from being dislodged. In a large solar panel grid, this can be a time consuming process that needs to be carried out on a regular basis.

### BRIEF SUMMARY

There is provided a solar panel washer that has a frame that is movable along a solar panel or solar panel grid. The frame has at least one elongate support that has a first end and a second end. The frame is supported by a set of frame wheels. The frame wheels are positioned such that the set of frame wheels rotate on a top surface of the solar panel. At least one nozzle is positioned on the frame. The at least one nozzle is attached to a hose such that a cleaning solution is sprayed onto the top surface of the solar panel. At least one brush is supported on the frame such that it contacts the top surface of the solar panel.

In one embodiment, the frame has a central elongate support and a pair of side elongate supports that are positioned such that the central elongate support and the pair of side elongate supports create a triangular shape. The pair of side elongate supports are positioned on either side of the brush.

In one embodiment, the at least one brush is a stationary brush that is affixed under the elongate support.

In one embodiment, the at least one brush is a rotatable circular brush. The rotatable circular brush may be rotated using a motor.

In one embodiment, the height of the at least one brush is adjustable. Where more than one brush is provided, each of the brushes may be adjusted independently of each other. Brush height may be adjusted using a slot with a set screw. This allows brush pressure on the solar panels to be set based on user preference.

In one embodiment, at least two nozzles are positioned on the frame, at least one nozzle is positioned such that cleaning solution is sprayed in a first direction and at least one nozzle is positioned such that cleaning solution is sprayed in a second direction.

In one embodiment, the frame further comprises a first wheel support and a second wheel support. The first wheel support is attached to the first end of the elongate support and the second wheel support is attached to the second end of the elongate support. The first wheel support and the second wheel support are perpendicular to the elongate support.

In one embodiment, a horizontal set of wheels are positioned on the wheel support such that the horizontal set of wheels rotate on a first side and a second side of the solar panel. The horizontal set of wheels maintain alignment of the frame on the solar panel.

In one embodiment, the frame is movable along the solar panels using a gimballed pole.

In another embodiment, the frame is movable along the solar panels by automated means.

In one embodiment, the length of the frame is adjustable.

In one embodiment, the set of frame wheels each have a spring assembly such that the set of frame wheels accommodate bumps or gaps between adjacent solar panels to be cleaned in the set of aligned solar panels.

In one embodiment, the elongate support is foldable between an operation mode and a transport and storage mode. A bridge connector is provided on the elongate support at a point of folding to hold the elongate support in the operation mode.

In one embodiment, the at least one nozzle are flat fan or tapered flat fan nozzles. In one embodiment, two sets of five nozzles per side for a total of ten nozzles are used. Each nozzle may provide a 110 degree spray pattern that contacts the solar panel at a 45 degree angle. There may be an overlap spray pattern between nozzles.

In one embodiment, the set of frame wheels have insulated bushings. Insulated bushings can help reduce the likelihood of electrical short or shorting of the solar panel washer.

In one embodiment, a first squeegee extends from the first wheel support to the second wheel support such that the first squeegee is positioned parallel to the elongate support.

In another embodiment, a second squeegee extends from the first wheel support to the second wheel support such that second squeegee is positioned parallel to the elongate support and on a side of the elongate support opposite the first squeegee.

In one embodiment, a cover is provided that extends from the first wheel support to the second wheel support such that the cover covers the at least one elongate support, the at least one nozzle, the hose, and the at least one brush.

In one embodiment, the cover has an extending portion that allows the length of the cover to be lengthened and shortened.

In another embodiment, a travel motor is provided in communication with the set of frame wheels to drive the set of frame wheels in a first direction or a second direction. The second direction is opposite to the first direction.

In one embodiment, a control box is provided in communication with the travel motor to provide operation controls to control the travel motor.

In another embodiment, at least one end stop sensor is provided. The at least one end stop sensor provides a signal to stop the set of frame wheels when an edge of the solar panel or the set of aligned solar panels is sensed.

### BRIEF DESCRIPTION OF THE DRAWINGS

These and other features will become more apparent from the following description in which references are made to the following drawings, in which numerical references denote like parts. The drawings are for the purpose of illustration only and are not intended to in any way limit the scope of the invention to the particular embodiments shown.

FIG. 1 is a perspective view of a solar panel washer.

FIG. 2 is a perspective view of a solar panel washer having a push handle.

FIG. 3 is a side elevation view of a portion of the solar panel washer with a squeegee in the engaged position.

FIG. 4 is a side elevation view of a portion of the solar panel washer with a squeegee in the disengaged position.

FIG. 5 is a side elevation view of the solar panel washer.

FIG. 6 is a detailed view of a nozzle used on the solar panel washer.

FIG. 7 is a detailed view of an alternative nozzle used on the solar panel washer.

FIG. 8 is a detailed view of a length adjustment mechanism.

FIG. 9 is a detailed view of the length adjustment mechanism and spring assembly.

FIG. 10 is a front elevation view of the solar panel washer with a cover.

FIG. 11 is a detailed view of a motor and control box used on the solar panel washer.

FIG. 12 is a side elevation view of the solar panel washer with motor and control box.

FIG. 13 is a detailed view of the solar panel washer with gearbox and battery.

FIG. 14 is a side elevation view of the solar panel washer with gearbox and battery.

FIG. 15 is a detailed view of the solar panel washer having an end stop sensor.

FIG. 16 is a top plan view of the solar panel washer.

FIG. 17 is a detailed view of the solar panel washer having a water valve shutoff.

FIG. 18 is a perspective view of the solar panel washer with a cover.

FIG. 19 is a detailed view of the solar panel washer with a cover and water valve shutoff.

### DETAILED DESCRIPTION OF THE PREFERRED EMBODIMENTS

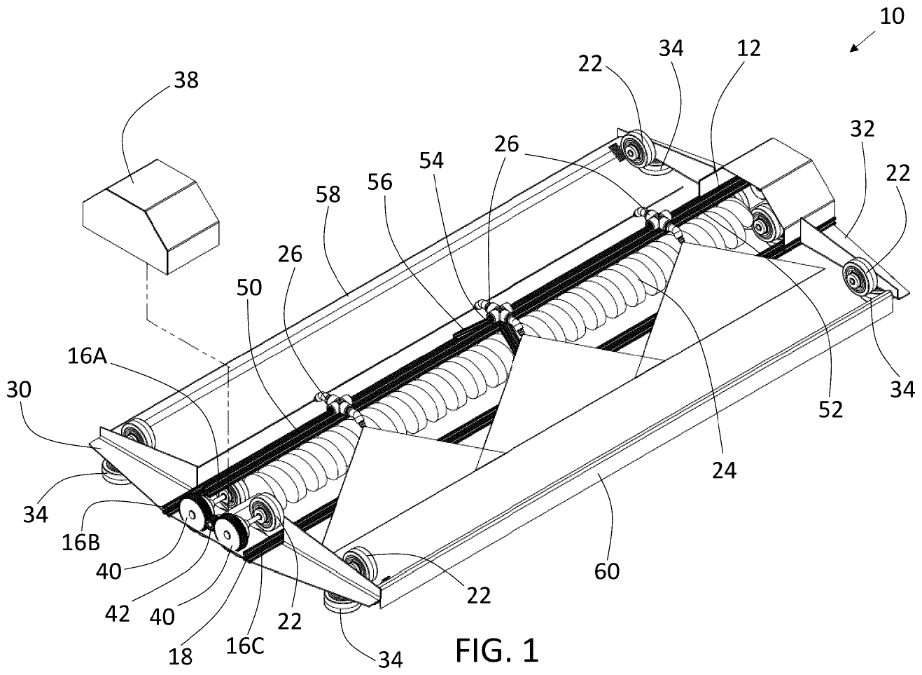

A solar panel washer, generally identified by reference numeral 10, will now be described with reference to FIG. 1 through FIG. 19.

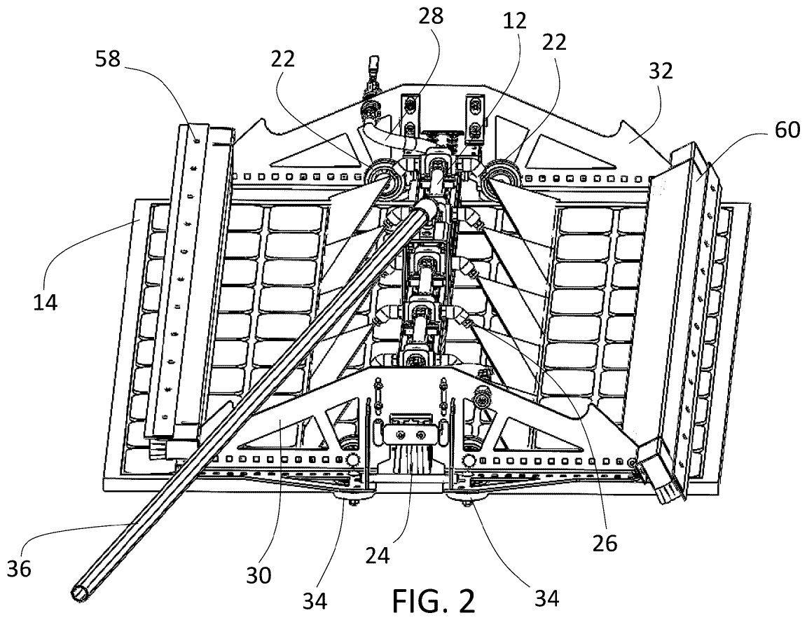

Referring to FIG. 1, solar panel washer 10 has a frame 12 that is movable along a solar panel 14, shown in FIG. 2, or set of aligned solar panels. In the embodiment shown, frame 12 has three elongate supports 16A, 16B, and 16C that each have a first end 18 and a second end 20. In the embodiment shown, elongate support 16A is a central elongate support and elongate supports 16B and 16C are side elongate supports that create a triangular shape. It will be understood by a person skilled in the art that a single elongate support, multiple elongate supports, and different positioning of elongate supports may be used. Frame 12 is supported by a set of frame wheels 22. Frame wheels 22 are positioned such that they rotate on a top surface of solar panel 14 to allow frame 12 to move. In the embodiment shown, eight frame wheels 22 are provided, however it will be understood that a single frame wheel 22 or multiple frame wheels 22 may be used. If a single frame wheel 22 is used, there are potential issues related to balance of frame 12 that would need to be factored in. It is preferable that at least one frame wheel 22 be used to provide support adjacent first end 18 of frame 12 and at least one frame wheel 22 be used to provide support adjacent second end of frame 12.

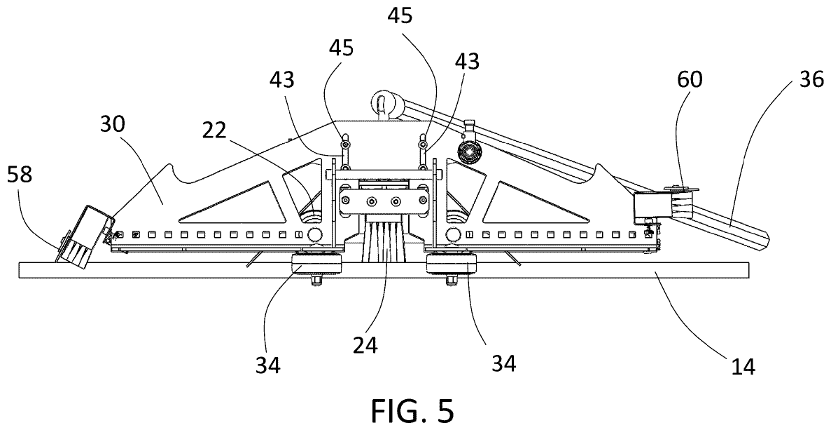

A brush 24 is supported by frame 12 such that brush 24 contacts the top surface of solar panel 14. In the embodiment shown, brush 24 is a rotatable circular brush. However, it will be understood by a person skilled in the art that other suitable brushes may be used. In the embodiment shown in FIG. 1, brush 24 is stationary. It will be understood by a person skilled in the art that brushes 24 may be stationary, may be any shape, or may be rotatable through mechanized means. In the embodiment shown in FIG. 1, brush 24 is rotated using a gear mechanism. Two outer gears 40 are connected to frame wheels 22 and a central gear 42. Central gear 42 is connected to brush 24 such that central gear 42 and brush 24 rotate in a direction opposite to the direction of rotation of outer gears 40 and frame wheels 22. It will be understood that motor 38 may also be supplied to cause rotation of brush 24. In the embodiment shown, motor 38 causes brush 24 and central gear 42 to rotate which in turn causes outer gears 40 and wheels 22 to rotate and move frame 12 along solar panel 14. In the embodiment shown in FIG. 5, the height of brush 24 is adjustable using a slot 43 and set screw 45. This allows different pressures to be placed on solar panel 14 during cleaning. Where more than one brush 24 is provided, each brush 24 may be adjustable independently of each other. It will be understood that different methods of adjusting the height of brush 24 may be used.

Nozzles 26 are positioned on frame 12. In the embodiment shown, six nozzles 26 are provided, however it will be understood by a person skilled in the art that a single nozzle 26 or multiple nozzles 26 may be used. Nozzles 26 are attached to a hose 28 to allow cleaning solution to be supplied to nozzles 26 and sprayed onto the top surface of solar panel 14. As can be seen in the embodiments shown, nozzles 26 may be positioned such that they spray in different directions. Nozzles 26 spraying in a first direction are used to loosen and wet dirt and debris before brush 24 scrubs it, while nozzles 26 spraying in a second direction are used to spray away the scrubbed dirt and debris. While not shown, it will be understood that nozzles may be positioned to spray in a downwards orientation or any other suitable orientation that results in contact of cleaning solution on the top surface of solar panel 14. While not required, it is preferable that the streams of cleaning solution overlap such that the entire length of solar panel 14 may be sprayed. This helps to create a more uniform cleaning.

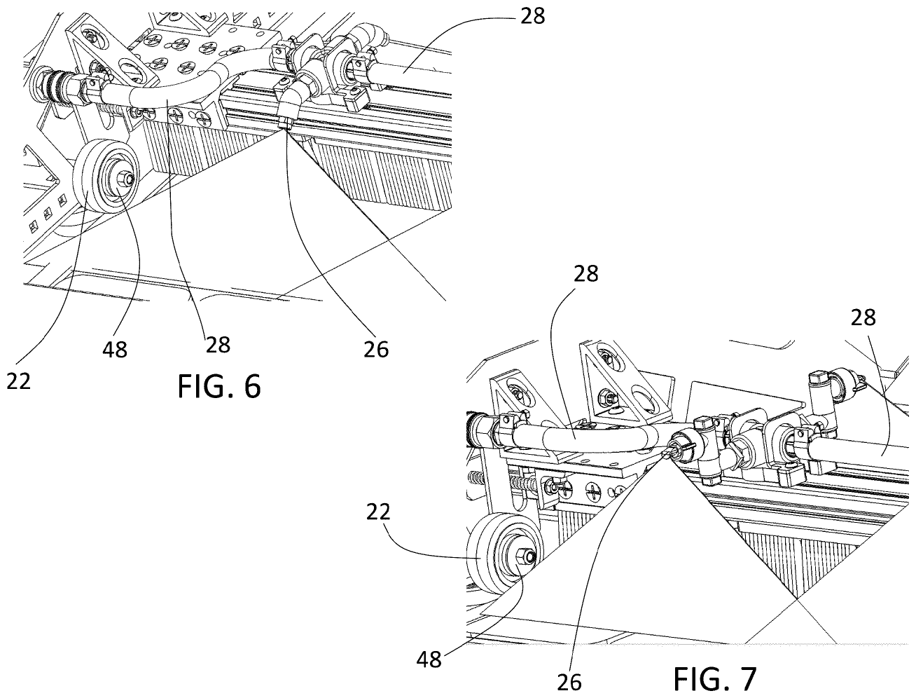

In the embodiments shown in FIG. 6 and FIG. 7, nozzle 26 is a flat fan or tapered flat fan nozzle. One version of this type of nozzle is sold under the trademark Teejet®. In the embodiment shown in FIG. 2, two sets of five nozzles per side for a total of ten nozzles are used. In the embodiment shown in FIG. 6, each nozzle provides a 110 degree spray pattern that contacts the solar panel at a 45 degree angle. In the embodiment shown in FIG. 7, the spray contacts the solar panel at an approximately 90 degree angle. There may be an overlap spray pattern between nozzles. It will be understood by a person skilled in the art that the degree of spray pattern may be altered. A narrower spray pattern may require the use of additional nozzles to prevent areas of solar panel 14 from being missed by cleaning fluid. Also, while it is preferable to have an overlapping spray pattern to ensure the entirety of solar panel 14 is sprayed, it will be understood that overlap is not required. The 45 degree angle or 90 degree angle at which the cleaning fluid contacts the solar panel may also be changed.

In the embodiments shown, frame 12 has a first wheel support 30 and a second wheel support 32 that are positioned perpendicular to elongate supports 16A, 16B, and 16C. frame wheels 22 are positioned on first wheel support 30 and second wheel support 32. A horizontal set of wheels 34 are positioned on first wheel support 30 and second wheel support 32 such that wheels 34 rotate on a first side and a second side of solar panel 14. This helps to maintain alignment of frame 12 on solar panel 14 as frame 12 moves. In the embodiment shown, first side of solar panel 14 is a top edge of solar panel 14 and second side of solar panel 14 is a bottom edge of solar panel 14. It will be understood by a person skilled in the art that different edges of solar panel 14 may be contacted by wheels 34 depending upon how solar panels 14 are aligned with each other and how frame 12 is placed of solar panels 14.

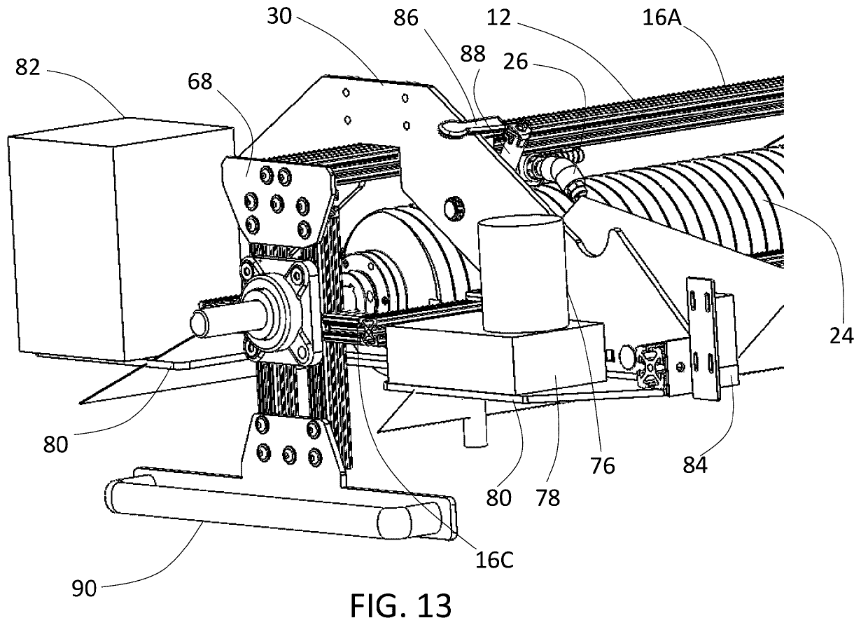

Referring to FIG. 5, frame 12 is movable along solar panels 14 and set of aligned solar panels 14 by manual or automated means. A gimballed pole 36 allows frame 12 to be moved from a distance. Gimballed pole 36 may have an adjustable length and is hingedly or pivotally attached to frame 12 so that frame 12 is movable in both a forward and rearward direction and the angle of gimballed pole 36 can be changed depending on the position of the user relative to solar panel 14 and frame 12. Referring to FIG. 1, frame 12 may be movable through automated means such as through the use of a motor which drives frame wheels 22 and/or horizontal wheels 34. Motor 38 which drives brush 24 may also be set up to drive frame wheels 22 and/or horizontal wheels 34, however a second motor, such as travel motor 76, shown in FIG. 13, may also be used.

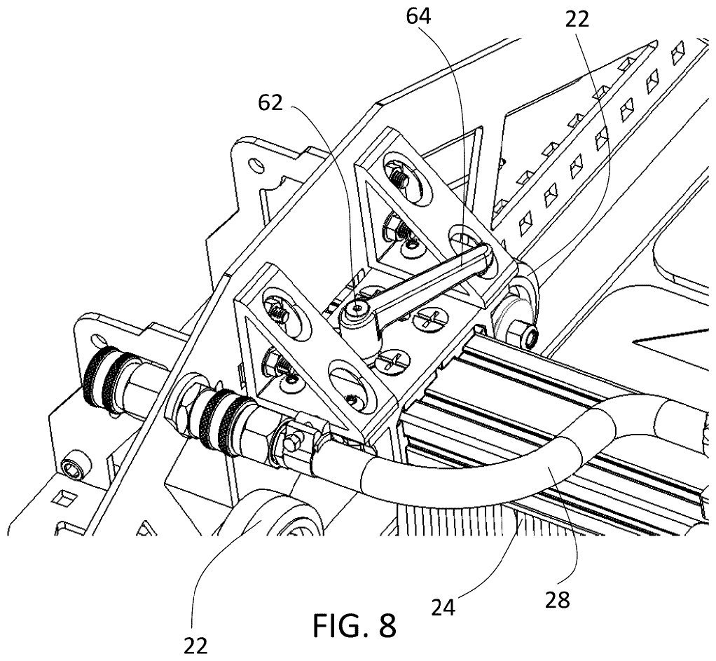

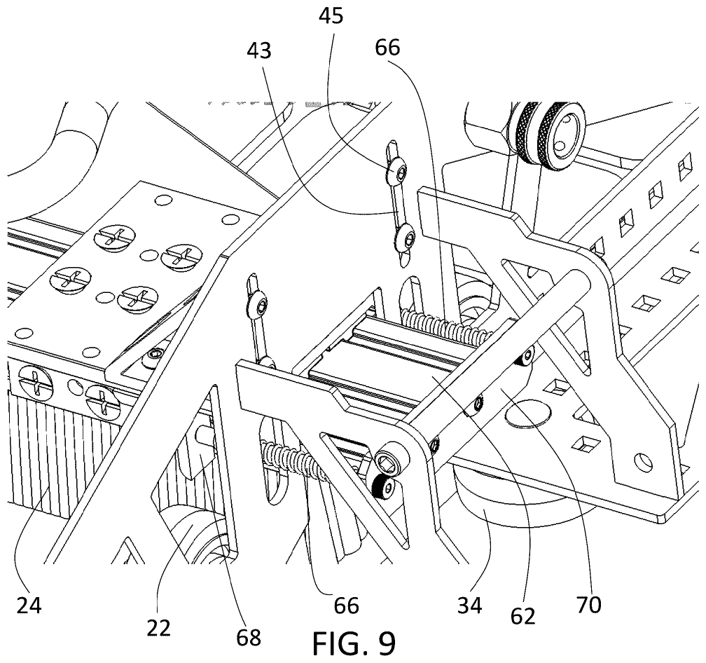

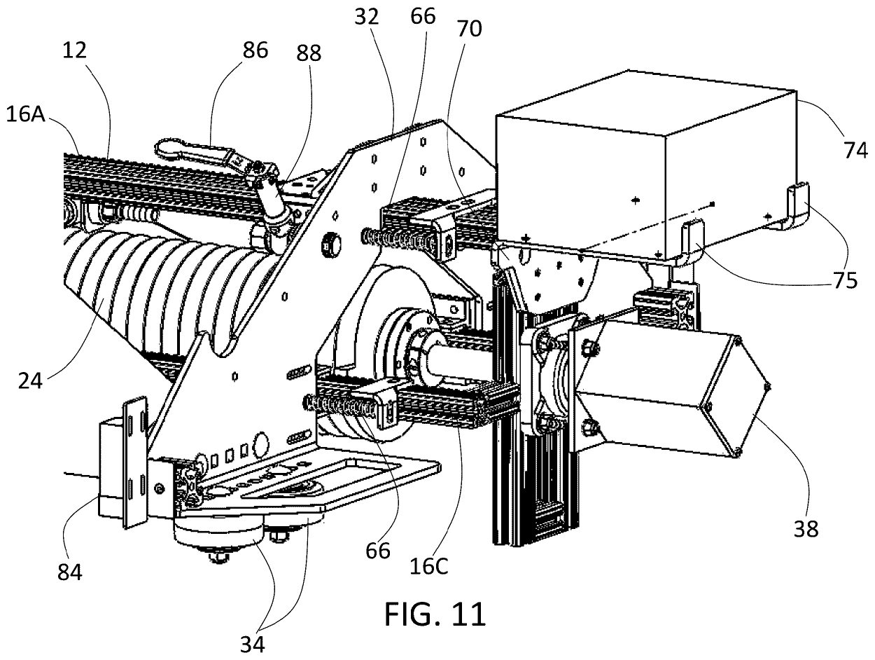

In the embodiment shown in FIG. 8 and FIG. 9, the length of frame 12 is adjustable using a spring loaded length adjustment mechanism 62. Referring to FIG. 8, adjustment mechanism 62 has a handle 64 that moves between a locked position and an unlocked position. In the locked position, the handle 64 prevents lengthening or shortening of frame 12. When moved to the unlocked position, frame 12 may be lengthened or shortened as needed to fit frame 12. Referring to FIG. 9, adjustment mechanism 62 has a pair of springs 66. Springs 66 attach to a stationary block 68 at one end and a movable block 70 at the other end. Movable block 70 is attached to horizontal wheels 34 on one side of frame 12. Movable block 70 slides relative to stationary block 68 to lengthen and shorten frame 12. Springs 66 limit motion of movable block 70. Springs 66 with different resistances can be used to allow for more or less motion of movable block 70 when handle 64, shown in FIG. 8, is in the unlocked position. It will be understood by a person skilled in the art that adjustment mechanism 62 may be positioned on one or both ends of frame 12. In the embodiment shown in FIG. 11, additional springs 66 are provided to assist with adjustments and help to keep elongate supports 16A, 16B, and 16C of frame 12 at the same length such that solar panel washer 10 maintains a consistent shape and does not become off balance due to different lengths existing between elongate supports 16A, 16B, and/or 16C.

Frame wheels 22 may have a spring assembly that act as shock absorbers. This allows frame wheels 22 to accommodate bumps or gaps between adjacent solar panels that are being cleaned by solar panel washer 10 in a set of aligned solar panels 14. Referring to FIG. 9, springs 66 may act as the spring assembly. It will be understood by a person skilled in the art that different types of shock absorbers may be used and that frame wheels 22 and horizontal wheels 34 may both have shock absorbers. Referring to FIG. 6, to help limit the risk of electric shock or shorting, frame wheels 22 may have insulated bushings 48.

Elongate supports 16A, 16B, and 16C may be foldable between an operation mode, shown in FIG. 1, and a transport and storage mode, not shown. Referring to FIG. 1, elongate supports 16A, 16B, and 16C are made up of a first portion 50 and a second portion 52 that are hingedly attached to each other at a point of folding 54. A bridge connector 56 is provided that holds first portion 50 and second portion 52 in the operation mode.

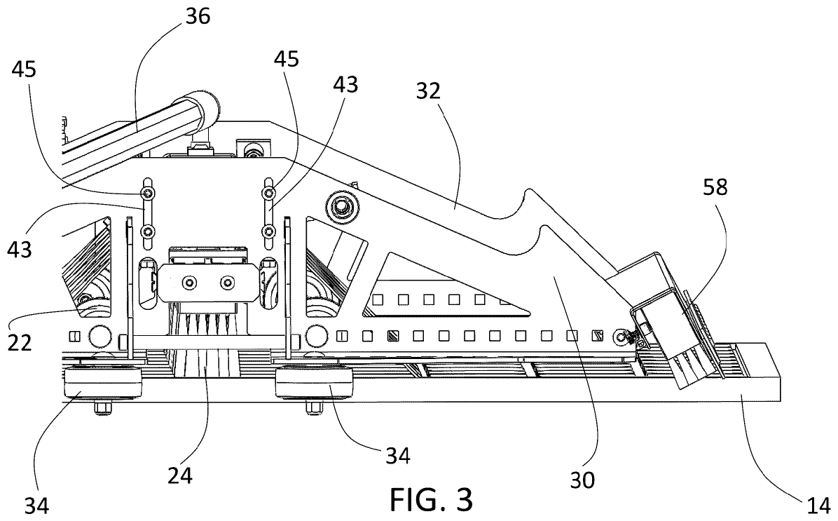

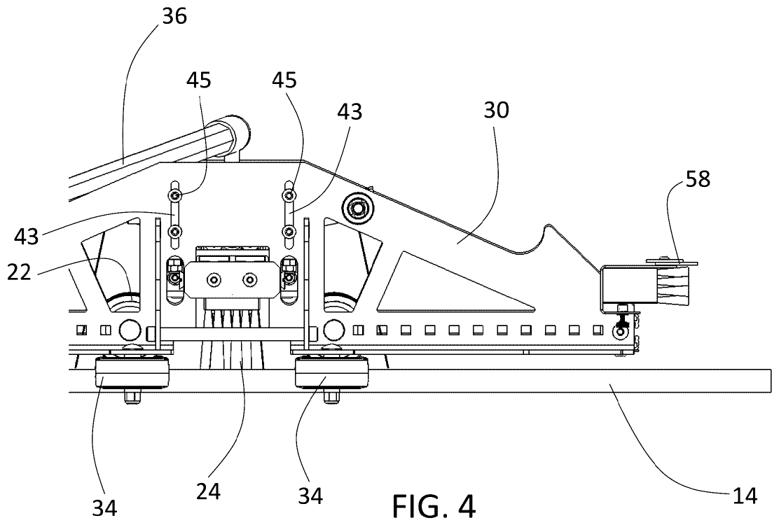

In the embodiment shown in FIG. 1, solar panel washer 10 has a first squeegee 58 and a second squeegee 60. It will be understood by a person skilled in the art that both first squeegee 58 and second squeegee 60 are not required and that a single squeegee may be positioned on solar panel washer 10. First squeegee 58 is supported by first wheel support 30 and second wheel support 32 and is positioned parallel to elongate supports 16A, 16B, and 16C. Second squeegee 60 is supported by first wheel support 30 and second wheel support 32 and is positioned parallel to elongate supports 16A, 16B, and 16C. Second squeegee 60 is positioned on a side of the elongate supports 16A, 16B, and 16C opposite first squeegee 58. First squeegee 58 and second squeegee 60 may be rotated into or out of contact with solar panels 14. Generally, when solar panel washer 10 is moving in a direction towards first squeegee 58, first squeegee 58 will be rotated up such that it is out of contact with solar panel 14. Second squeegee 60 is rotated into contact with solar panels 14 such that cleaning solution, dirt and grime are squeegeed off of solar panel 14. When solar panel washer 10 is moving in a direction towards seconds squeegee 60, second squeegee is rotated up such that it is out of contact with solar panel 14 and first squeegee 58 is rotated into contact with solar panels 14. Referring to FIG. 3 and FIG. 4, first squeegee 58 and second squeegee 60, not shown, are hingedly attached to first wheel support 30 and second wheel support 32 such that first squeegee 58 and second squeegee 60 are movable between a use position, shown in FIG. 3. and a non-use position, shown in FIG. 4. First squeegee 58 and second squeegee 60 may be held in the use or the non-use position by clip, tie, aperture and pin, or any other method known to a person skilled in the art. First squeegee 58 and second squeegee 60 can both be in the use position, in the non-use position, or one may be in the use position and the other may be in the non-use position.

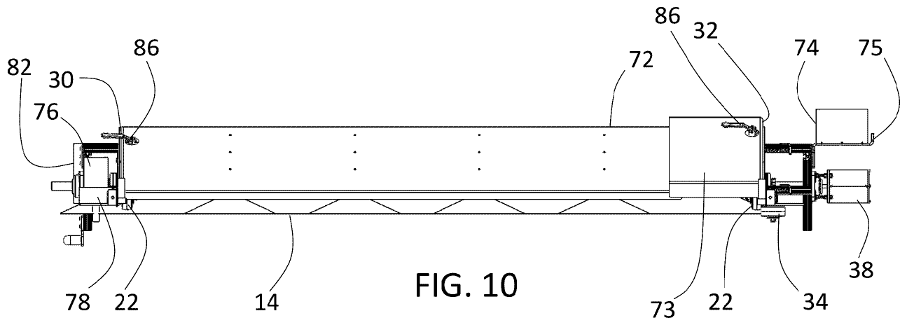

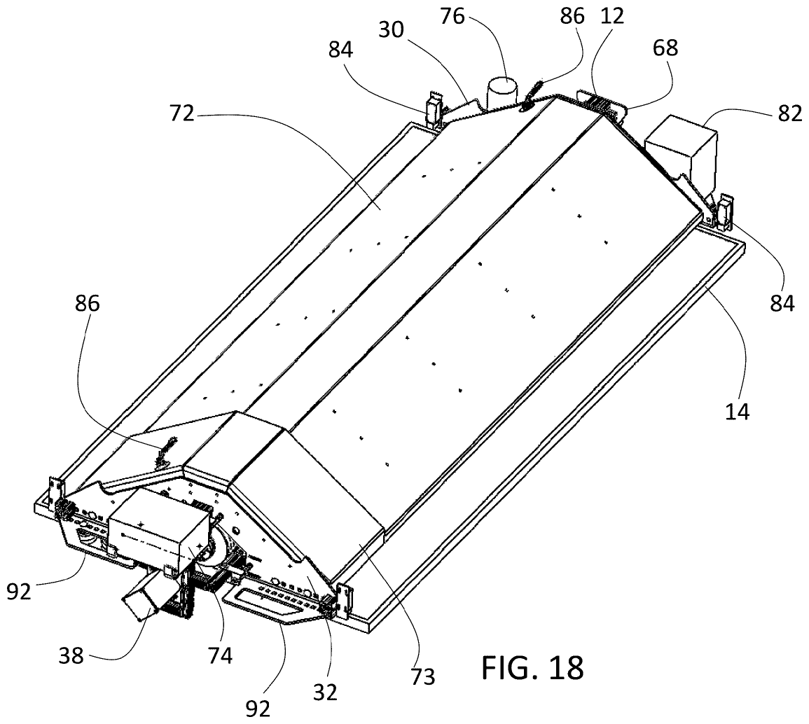

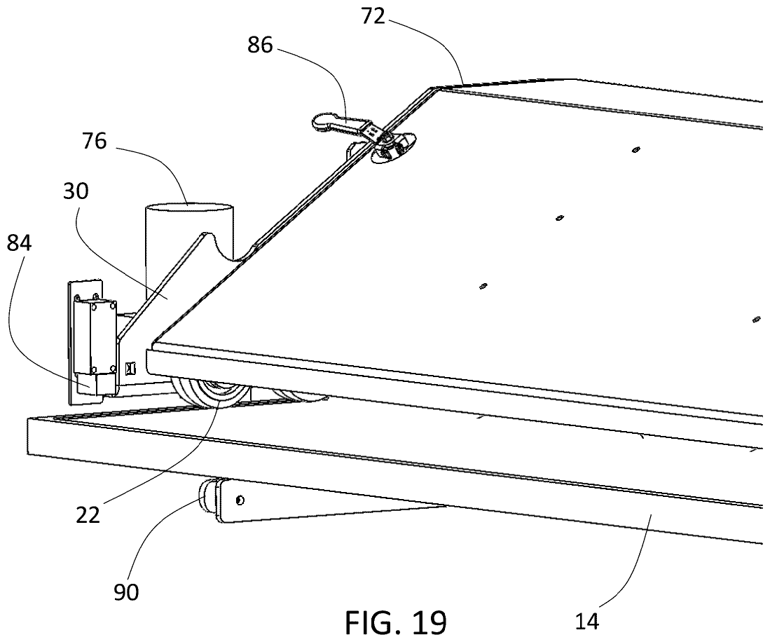

In the embodiments shown in FIG. 10, FIG. 18, and FIG. 19, solar panel washer 10 has a cover 72 that extends between first wheel support 30 and second wheel support 32 to provide protection for nozzle 26, elongate supports 16A, 16B, and 16C, hose 28, and brush 24, all shown in FIG. 2, along with any other elements shielded by cover 72. Cover 72 may also block fluid from being sprayed at operators or personnel near solar panel washer 10. Cover 72 can help prevent damage to solar panel washer 10 caused by foreign bodies entering solar panel washer from above. Cover 72 may also prevent large objects from passing through brush 24 if there is insufficient clearance between cover 72 and solar panels 14 to allow object to pass to an interior of cover 72. Solar panel washer 10 may operate without cover 72 and cover 72 may be removable to allow access to parts of solar panel washer 10 located under cover 72 for maintenance, repair, or inspection. Referring to FIG. 10 and FIG. 18, cover 72 may have an extending portion 73 that allows for cover 72 to change in length when frame 12 is lengthened and shortened.

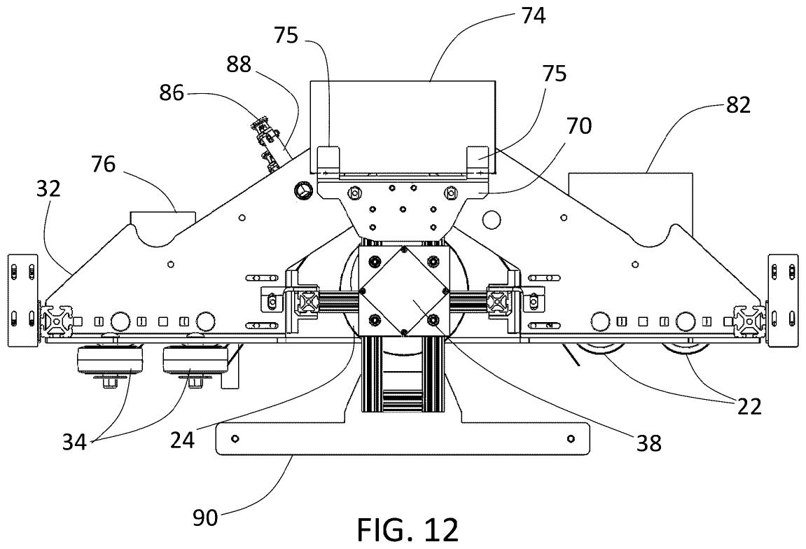

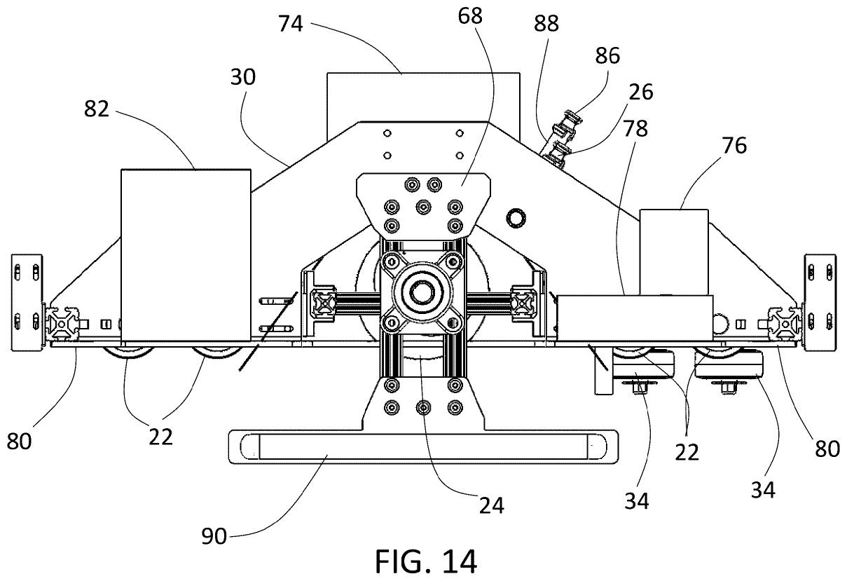

In the embodiment shown in FIG. 11 and FIG. 12, motor 38 is positioned on a side of solar panel washer 10 in communication with brush 24 such that rotation of motor 38 causes rotation of brush 24. In the present embodiment, motor 38 is supported on second wheel support 32, however it will be understood by a person skilled in the art that motor could be supported on first wheel support 30, cover 72, or by any other suitable element of solar panel washer 10. Motor 38 is electrically connected to a control box 74 which provides operational controls or wireless communication to operational controls for motor 38. Control box 74 is supported on solar panel washer 10 by brackets 75 connected to movable block 70. In the embodiments shown in FIG. 13 and FIG. 14, a travel motor 76 with gear box 78 is provided for driving frame wheels 22 and/or wheels 34. In the embodiments provided, mounts 80 are attached to first wheel support 30 and travel motor 76 with gear box 78 and battery 82 are supported on mounts 80. This would allow for movement of solar panel washer 10 without physical labour from the operator. Travel motor 76 and gear box 78 are electrically connected to control box 74. A battery 82 is provided as an energy source for travel motor 76, control box 74, and motor 38. It will be understood by a person skilled in the art that travel motor 76 and motor 38 could be fuel driven motors or electrically driven motors. Controls may allow solar panel washer 10 to move forward, backwards, speed up, slow down, turn on, turn off, stop, or any other suitable command known to a person skilled in the art through manipulation of travel motor 76 and gear box 78. Controls may also turn on and off rotation of brush 24, change the speed of brush 24, or change the direction of rotation of brush 24 through manipulation of motor 38. Operational controls may be human driven, AI driven, or controlled by computer program.

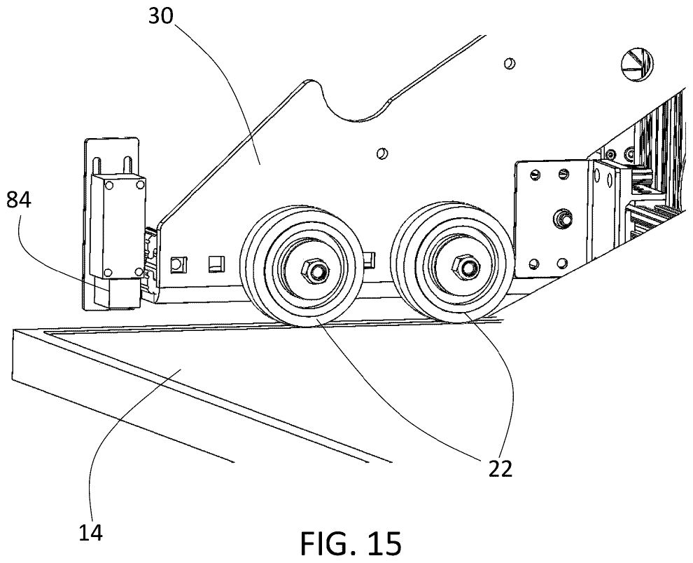

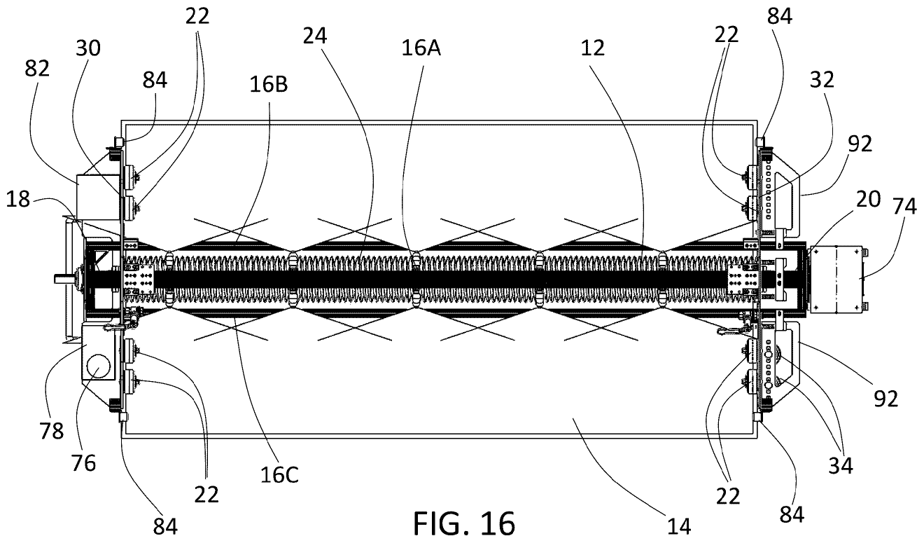

In the embodiment shown in FIG. 15, solar panel washer 10 is equipped with an end stop sensor 84 which helps to prevent solar panel washer 10 from travelling off of a solar panel array when in use. End stop sensor 84 may be provided in communication with control box 74, travel motor 76, and/or battery 82 such that triggering of end stop sensor 84 results in the termination of movement of solar panel washer 10. In the embodiment shown in FIG. 16, end stop sensors 84 are positioned on the ends of first wheel support 30 and second wheel support 32. End stop sensors 84 may be programmed to terminate movement at the edge of a solar panel 14 or may be programmed to terminate if a predetermined space exists between edges of adjacent solar panels 14. Allowing for some space between adjacent solar panels can help eliminate inadvertent stops during the cleaning of a solar panel array with gaps between solar panels that solar panel washer 10 can safely traverse.

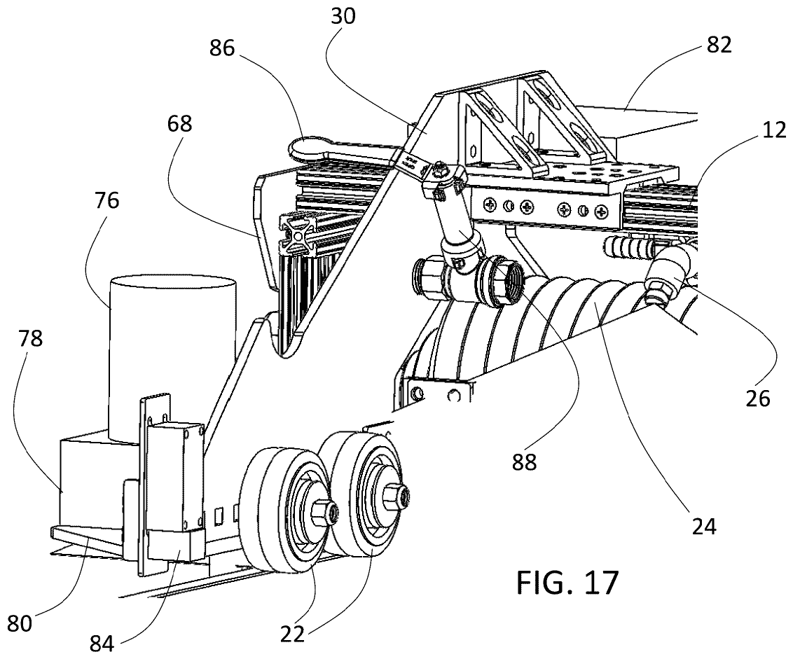

In the embodiment shown in FIG. 17, a fluid shutoff valve 86 is provided to control the flow of fluid through hose 28. Fluid shutoff valve 86 may be useful when a break occurs in hose 28, not shown in FIG. 17, when solar panel washer 10 is used without fluid, or when a fluid source is being changed. A valve extension 88 may be provided to allow for greater clearance of fluid shutoff valve 86 relative to cover 72. Referring to FIG. 18, a fluid shutoff valve 86 may be positioned at either end of hose 28 or on both ends of hose 28.

In the embodiments shown in FIG. 12, FIG. 13, and FIG. 14, a handle 90 is provided to assist in lifting of solar panel washer 10 for transport or on and off of solar panels. Handle 90 may be left bare or may be coated in plastic, rubber, or any other suitable material known to a person skilled in the art. In the embodiments shown, handle 90 is positioned on a support structure attached to movable block 70. It will be understood by a person skilled in the art that handle 90 may be positioned in any suitable location on solar panel washer 10, such as on frame 12, first wheel support 30, or second wheel support 32. In the embodiment shown in FIG. 18, handles 92 are fixedly attached to second wheel support 32.

Any use herein of any terms describing an interaction between elements is not meant to limit the interaction to direct interaction between the subject elements, and may also include indirect interaction between the elements such as through secondary or intermediary structure unless specifically stated otherwise.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent that changes may be made to the illustrative embodiments, while falling within the scope of the invention. As such, the scope of the following claims should not be limited by the preferred embodiments set forth in the examples and drawings described above, but should be given the broadest interpretation consistent with the description as a whole.

What is claimed is:

1. A solar panel washer, comprising:
a frame having at least one elongate support having a first end and a second end;
the frame being supported by a set of frame wheels, the frame wheels being positioned such that the set of frame wheels rotate on a top surface of a solar panel such that the frame is movable along the solar panel or a set of aligned solar panels;
at least one nozzle being positioned on the frame, the at least one nozzle being attached to a hose such that a cleaning solution is sprayed onto the top surface of the solar panel; and
at least one brush supported on the frame such that it contacts the top surface of the solar panel.

2. The solar panel washer of claim 1 wherein the frame has a central elongate support and a pair of side elongate supports being positioned such that the central elongate support and the pair of side elongate supports create a triangular shape, the pair of side elongate supports being positioned on either side of the brush.

3. The solar panel washer of claim 1 wherein the at least one brush is a rotatable circular brush.

4. The solar panel washer of claim 3 wherein the at least one brush is rotated using a motor.

5. The solar panel washer of claim 1 wherein the height of the at least one brush is adjustable.

6. The solar panel washer of claim 1 wherein at least two nozzles are positioned on the frame, at least one nozzle being positioned such that cleaning solution is sprayed in a first direction and at least one nozzle being positioned such that cleaning solution is sprayed in a second direction.

7. The solar panel washer of claim 1 wherein the frame further comprises a first wheel support being attached to the first end of the elongate support, the first wheel support being perpendicular to the elongate support, and a second wheel support being attached to the second end of the elongate support, the second wheel support being perpendicular to the elongate support, the set of frame wheels being positioned on the first wheel support and the second wheel support.

8. The solar panel washer of claim 7 wherein a horizontal set of wheels are positioned on the first wheel support and the second wheel support such that the horizontal set of wheels rotate on a first side and a second side of the solar panel, the horizontal set of wheels maintaining alignment of the frame on the solar panel.

9. The solar panel washer of claim 1 wherein the frame is movable along the solar panels by automated means.

10. The solar panel washer of claim 1 wherein the length of the frame is adjustable.

11. The solar panel washer of claim 1 wherein the set of frame wheels having a spring assembly such that the set of frame wheels accommodate bumps or gaps between adjacent solar panels to be cleaned in the set of aligned solar panels.

12. The solar panel washer of claim 1 wherein the elongate support is foldable between an operation mode and a transport and storage mode, a bridge connector being provided on the elongate support at a point of folding to hold the elongate support in the operation mode.

13. The solar panel washer of claim 1 wherein the at least one nozzle are flat fan or tapered flat fan nozzles.

14. The solar panel washer of claim 1 wherein the set of frame wheels have insulated bushings.

15. The solar panel washer of claim 7 wherein a first squeegee extends from the first wheel support to the second wheel support such that the first squeegee is positioned parallel to the elongate support.

16. The solar panel washer of claim 15 wherein a second squeegee extends from the first wheel support to the second wheel support such that second squeegee is positioned parallel to the elongate support and on a side of the elongate support opposite the first squeegee.

17. The solar panel washer of claim 1 wherein a cover extends from the first wheel support to the second wheel support such that the cover covers the at least one elongate support, the at least one nozzle, the hose, and the at least one brush.

18. The solar panel washer of claim 17 wherein the cover has an extending portion that allows the length of the cover to be lengthened and shortened.

19. The solar panel washer of claim 9 further comprising a travel motor, the travel motor being in communication with the set of frame wheels to drive the set of frame wheels in a first direction or a second direction, the second direction being opposite to the first direction.

20. The solar panel washer of claim 1 further comprising at least one end stop sensor, the at least one end stop sensor providing a signal to stop the set of frame wheels when an edge of the solar panel or the set of aligned solar panels is sensed.
